(19) United States
(12) Patent Application Publication
(10) Pub. No.: US 2010/0202257 A1
(43) Pub. Date: Aug. 12, 2010

(54) REPRODUCTION OUTPUT CONTROL APPARATUS, REPRODUCTION OUTPUT CONTROL METHOD, OR THE LIKE

(75) Inventor: Shinichiro Abe, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Minato-ku, Tokyo (JP)

(21) Appl. No.: 11/910,439

(22) PCT Filed: Mar. 28, 2006
(86) PCT No.: PCT/JP2006/306257

§ 371 Date: Oct. 1, 2007

(30) Foreign Application Priority Data
Mar. 29, 2005 (JP) 2005-093551

(51) Int. Cl. G11B 7/085

(52) U.S. Cl. 369/30.08; G9B/7.042

(57) ABSTRACT

There are provided a reproduction output control apparatus, a reproduction output control method, a reproduction output control processing program and so on which can quickly (in a short time) search a desirable program information out of program information such as a plurality of song data which are continuously recorded on a recording means.

The reproduction output control apparatus according to the present application includes:
a reproduction control means for reproducing a plurality of program information pieces recorded on a recording means; and
an output control means for causing the plurality of program information pieces output at least two program information pieces out of the plurality of program information pieces thus reproduced respectively from different output means.

### TECHNICAL FIELD

The present invention relates to a technical field of an apparatus, a method or the like for reproducing program information such as a plurality of song data or the like which are recorded on a recording medium such as an optical disc.

### BACKGROUND ART

One type of an information reproducing apparatus is typically constructed to scan (search) a large number of songs, which are recorded on for example an optical disc or the like, and sequentially reproduce (play) song heads (head portions). (For example, vide Patent Document 1)

According to such the information reproduction apparatus, a user can select a predetermined song by listening song heads (head portion) of a large number of songs which are recorded on the optical disk.

### Patent Document 1: Japanese Unexamined Patent Publication 62-034356

### DISCLOSURE OF THE INVENTION

### Problems that the Invention is to Solve

However, in such the type of the information reproduction apparatus of sequentially reproducing the song heads of the songs, there is a problem that it is necessary to spend a substantial time for reaching (searching) a predetermined song desired by the user.

Especially, in accordance with increment of recording medium (means) capacity and development of data compression technique such as MP(MPEG Audio Layer) 3 and ATRAC (Adaptive Transform Acoustic Coding) 3, a number of songs which can be recorded onto a single recording means drastically increases. Therefore, it is necessary to spend a very long time in reaching a song desired by a user.

Therefore, according to the present invention, an object of the present invention is to provide a reproduction output control apparatus, a reproduction output control method, a reproduction output control processing program or the like which can rapidly search predetermined program (in a short time) out of program information such as a plurality of song data, which are recorded onto a recording medium.

### A Means for Solving the Problem

In order to solve the above object, according to a first aspect of the present invention, there are provided a reproduction control means for reproducing a plurality of program information pieces recorded on a recording means; and an output control means for causing the plurality of program information pieces be outputted in a manner that at least two program information pieces among the plurality of program information pieces are reproduced respectively from different output means.

According to another aspect of the present invention, there are provided a step of reproducing a plurality of program information pieces recorded on a recording means; and a step of outputting the plurality of program information pieces thus reproduced to output at least two program information pieces out of the plurality of program information pieces from different output means.

According to another aspect of the present invention, it is caused function a computer to reproduce a plurality of program information pieces recorded on a recording means; and output the plurality of the program information pieces thus reproduced to output at least two program information pieces out of the plurality of the program information pieces thus reproduced from different output means.

According to another aspect of the present invention, a reproduction output control processing program is recorded so as to be readable by a computer.

### BRIEF DESCRIPTION OF THE DRAWINGS

FIG. 1 A view for showing a schematic structure of an information reproduction apparatus according to the present embodiment.

FIG. 2 A view for schematically showing an example of a state that the n-th song is allocated to an L channel and an n-th song is allocated to an R channel so that output timings of head portions for ten seconds of an n-th song (n=1, 2, 3 . . . k), which is reproduced for searching selection songs, and the (n+1)-th song, partly overlap.

FIG. 3 A view for schematically showing an example of a state that an n-th song is allocated to an L channel and an (n+1)-th song is allocated to an R channel so that output timings of head portions for ten seconds of the n-th song (n=1, 2, 3 . . . k), which is reproduced for searching selection songs, and the (n+1)-th song, partly overlap.

FIG. 4 A flow chart for showing processing in the system control unit 22 in searching selection songs.

FIG. 5 A schematic view for showing an example of content in a buffer memory 17.

### EXPLANATION OF NUMERICAL REFERENCES

1: Information Reproduction Apparatus
15: Information Reading Unit
16: Digital Signal Processing Unit
17: Buffer Memory
18a, 18b: DAC
19a, 19b: Amplifier
20a, 20b: Speaker
21: Operation and Display Unit
22: System Control Unit

### BEST MODES FOR CARRYING OUT THE INVENTION

Hereinafter, a best mode for carrying out the present invention will be described in reference of the attached figures. The embodiments described below are cases where the present invention is applied to an information reproduction apparatus for reproducing a song from an optical disc (an example of recording means) having a plurality of song (music song) data (example of program information) recorded on it.

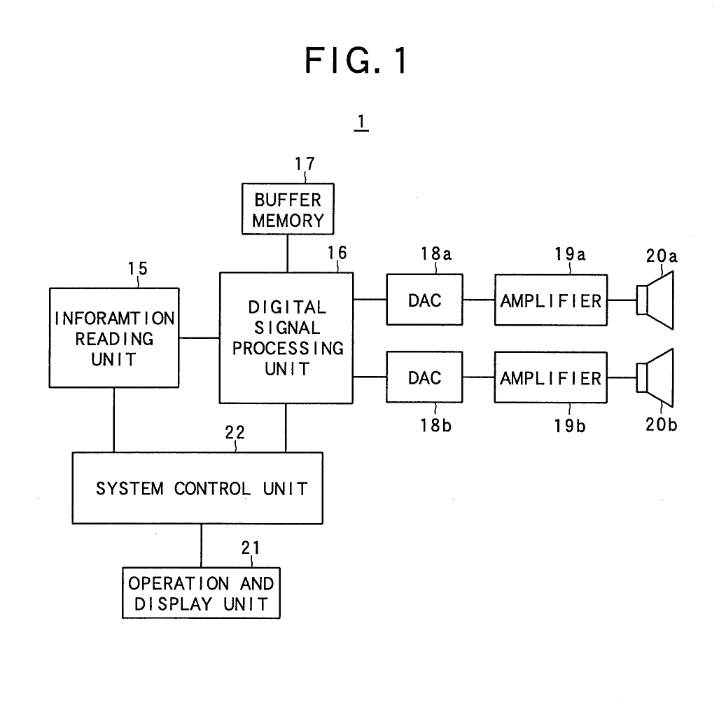

First, in reference of FIG. 1 or the like, a structure and a function of the information reproduction apparatus according to the present embodiment will be described.

FIG. 1 shows the schematic structure of the information reproduction apparatus according to the present embodiment.

As shown in FIG. 1, the information reproduction apparatus 1 is constituted by an information reading unit 15, a digital signal processing unit 16, a buffer memory 17, DAC (Digital Analog Converter) 18a, 18b, Amplifiers 19a, 19b, Speakers 20a, 20b as an example of output means, an operation and display unit 21, a system control unit 22 and so on. The system control unit 22 or the system control unit 22 and the digital signal processing unit 16 constitute the reproduction output control apparatus according to the present invention.

The information reading unit 15 is constituted by a spindle motor, an optical pickup, a feed motor, an RF (Radio Frequency) amplifier, an actuator, a servo circuit or the like.

The spindle motor drives to rotate an optical disc (e.g. CD-DA), mounted on a clamping position of a drive mechanism (not shown), under a control of the servo circuit at a constant linear velocity. Further, in the embodiment, the spindle motor is driven to rotate at a speed faster (e.g. quad-speed) than an ordinary speed (equal to a standardized speed).

The feed motor is provided to feed the optical pickup in a radius direction of the optical disk. The optical pickup is to irradiate light beam onto the optical disc with a semiconductor laser device (not shown) and detects (reads out) a signal recorded on the optical disk in use of light reflected thereon. The RF amplifier generates an RF signal, a tracking error signal and a focusing error signal, detected from a signal recorded on the optical pickup. Further, in the embodiment, the optical pickup is controlled to read out information at a velocity faster (e.g. quad-speed) than an ordinary signal detecting velocity (information read-out velocity).

The servo circuit carries out the tracking servo control based on the tracking error signal and the focusing servo control signal based on the focusing error signal. Further, the servo circuit carries out a track jump control for moving the objective lens (not shown) of the optical pickup track by track and a feed control for moving the optical pickup in its entirety with the feed motor in searching for example songs.

The digital signal processing unit 16 is constituted by for example a DSP (Digital Signal Processor). Recorded information on the optical disc is reproduced by providing digital signal processing such as EFM decode processing (Eight to Fourteen Modulation) and error correction processing with respect to the RF signal. The digital signal processing unit 16 extracts digital song data of a left channel (hereinafter referred to as “L channel”) and digital song data of a right channel (hereinafter referred to as “R channel”), the digital song data being contained in the recorded information thus reproduced when for example these are ordinarily reproduced. After the digital song data are temporarily stored in the buffer memory, these are respectively outputted such that the digital song data of the L channel are outputted to DAC 18a and the song data of the R channel are outputted to DAC 18b. The buffer memory 17 has a memory capacity of for example several tens of MBs to thereby enable to store song data of about 30 seconds to 1 minute.

Further, when various servo are started up, the digital signal processing unit 16 extracts TOC (Table of Contents) information (including for example head absolute times respectively of the songs) recorded on a read-in area in the most inner periphery of the optical disc, and outputs to the system control unit 22.

DAC 18a, 18b converts the digital song data from the digital signal processing unit 16 to the analogue signal. The amplifier 19a amplifies an analogue signal from the DAC 18a and outputs it to the speaker 20a. The speaker 20a outputs the analogue signal thus amplified to an outside. Further, the amplifier 19b amplifies the analogue signal from the DAC 18b and outputs it. The speaker 20b outputs the analogue signal thus amplified to an outside as acoustic wave.

Operation buttons (for example, replay button, stop button, fast-forward button, rewind button, and song selection search button) are provided on the operation and display unit 21. An operation signal corresponding to the operation button pushed by the user is outputted to the system control unit 22. Further, the operation and display unit 21 has a display panel for displaying information such as track number of songs and play time of the songs recorded on the optical disc.

The system control unit 22 includes CPU (Central Processing Unit), RAM (Random Access Memory), ROM (Read Only Memory) for memorizing various data and programs, and so on. When CPU reads out a program (including reproduction output control processing program according to the present invention) memorized in for example ROM, the information reproduction apparatus 1 is totally controlled in its entirety and functions as the reproduction control means and the output control means. Namely, the system control unit 22 controls servo circuit, a digital signal processing unit 16 or the like, reads out a plurality of song data (hereinafter, referred to as simply “song”), which are continuously recorded on an optical disc at a rate faster than normal reproduction speed (e.g. quad-speed), stores these on the buffer memory 17, and causes these output out of the speaker 20a and the speaker 20b through the DAC 18a, 18b and the amplifier 19a and the amplifier 19b at an ordinary reproduction speed. Meanwhile, it may be possible to cause these reproduce at an ordinary reproduction speed and output at an ordinary speed out of the speaker 20a and the speaker 20b through the DAC 18a, 18b and the amplifier 19a and the amplifier 19b.

Furthermore, the system control unit 22 reads out and temporally stores into the buffer memory at a speed (e.g. quad-speed) faster than the ordinary reproduction speed for a predetermined time duration (ten seconds) from heads of a plurality of songs for example when selection songs are searched. When number of the songs thus stored reaches a predetermined stored amount, at least two songs out of the plurality of songs (the predetermined time duration from the head) are outputted from different speakers 20a or 20b, and the plurality of songs are outputted at the ordinary speed so that output timings of parts or all of at least two songs overlap. For example, tens seconds from the head of the second song are outputted from the speaker 20b at the same time when ten seconds from the head of the first song is outputted from the speaker 20a.

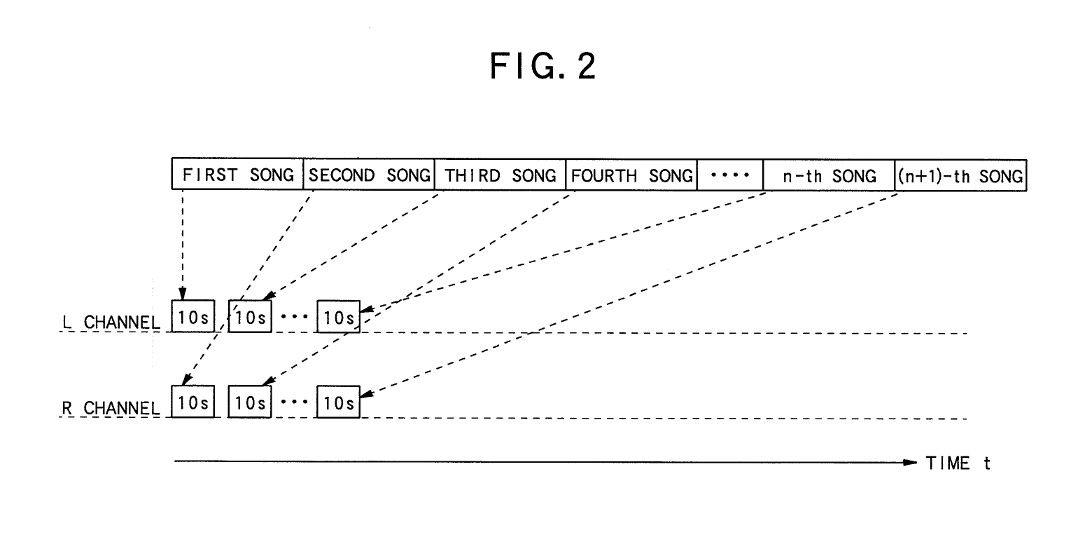

FIG. 2 is a schematic view for showing an example that the n-th song (n=1, 3 . . . ) is allocated to an L channel (i.e. speaker 20a corresponding to the L channel) and the (n+1)-th song is allocated to an R channel (i.e. speaker 20b corresponding to the R channel) so that all of output timings of ten seconds from the heads of an n-th song and (n+1)-th song reproduced by song selection search overlap.

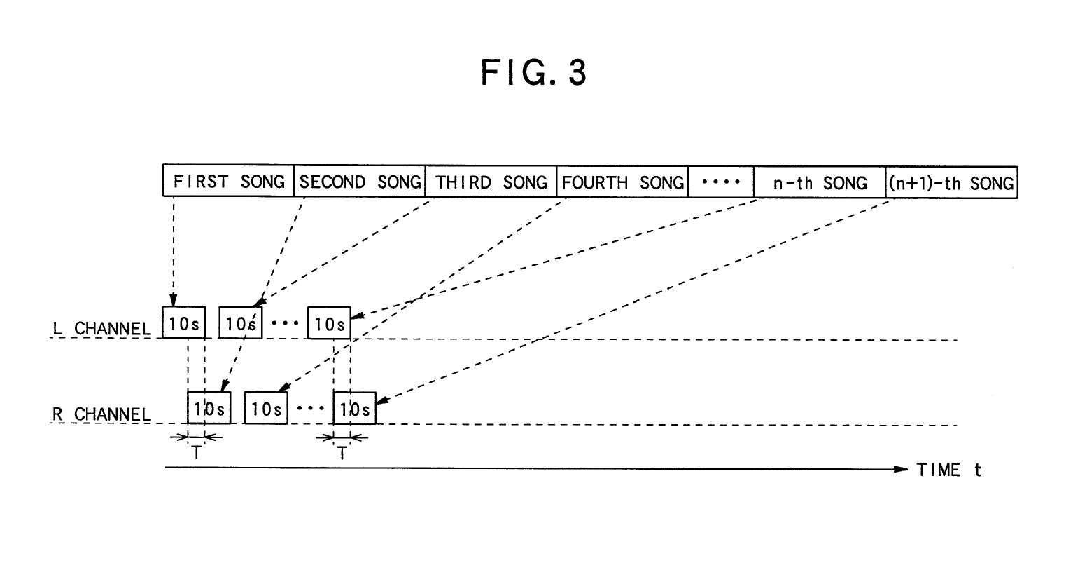

Further, FIG. 3 is a schematic view for showing an example that the n-th song (n=1, 3 . . . ) is allocated to an L channel and the (n+1)-th song is allocated to an R channel so that parts (overlap time T shown in FIG. 3) of output timings of ten seconds from the heads of an n-th song and (n+1)-th song, reproduced by the song selection search, overlap.

In Examples 2 and 3, along with an order of the plurality of songs (namely in an order of first, second, and third songs) outputs from each of the songs are alternately allocated to two channels of L channel and R channel, and outputted. By this, the user can rapidly (in a short time) search a predetermined song.

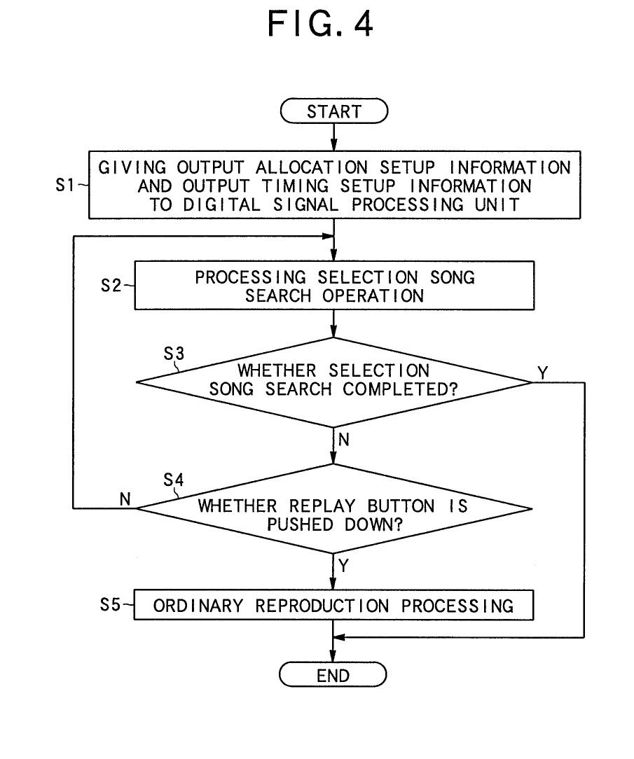

Next, an operation of the information reproduction apparatus 1 in searching songs will be described in reference of FIG. 4.

FIG. 4 is a flow chart for showing processing of the system control unit 22 in searching selection songs. In the following explanation, the system control unit 22 obtains the TOC information described above at a time of starting up various servos when the optical disc is set up in the information reproduction apparatus 1.

The process shown in FIG. 4 starts when a selection search button in the operation and display unit 21 is pushed down by for example a user. The system control unit 22 first provides the output allocation setup information and the output timing setup information with respect to the digital signal processing unit 16. (Step S1)

Here, the output allocation setup information has for example, information for respectively allocating output of the n-th song to an output port of the L channel in the digital signal processing unit 16 and an output of the (n+1)-th song to the output port of the R channel. Meanwhile, the output timing setup information includes, for example, information stipulating (in other words stipulating output timing difference of between the L channel and the R channel) the output timing of the song from the output ports of the L channel and the R channel in the digital signal processing unit 16.

When the digital signal processing unit 16 receives output allocation setup information and output timing setup information from the system control unit 22, it carries out setup of respectively allocating an output of the n-th song to the output port of the L channel and the output of the (N+1)-th song to the output port of the R channel on the basis of the output allocating setup information, and simultaneously sets up output timing of the song from the output ports of the L channel and the R channel on the basis of the output timing setup information.

Next, the system control unit 22 gives selection song search operation starting instruction to the servo circuit and the digital signal processing unit 16, and carries out the selection song search operation (Step S2).

In processing the selection song search operation, the system control unit 22 gives a search command or the like for seeking a recording position (target position) in the optical disc, indicated by head absolute times with respect to each of the songs included in TOC information to a servo circuit. By this, the objective lens of the optical pickup is moved toward the recording position by track jump control of the servo circuit, whereby the recording information in the head portions respectively of the songs is sequentially read out, digital signal processing such as EFM demodulation processing and error correction processing are provided with respect to the RF signal, a head of the song is reproduced for a predetermined time (for example ten seconds), and the predetermined time from the head of the song thus reproduced is temporally stored in the buffer memory 17.

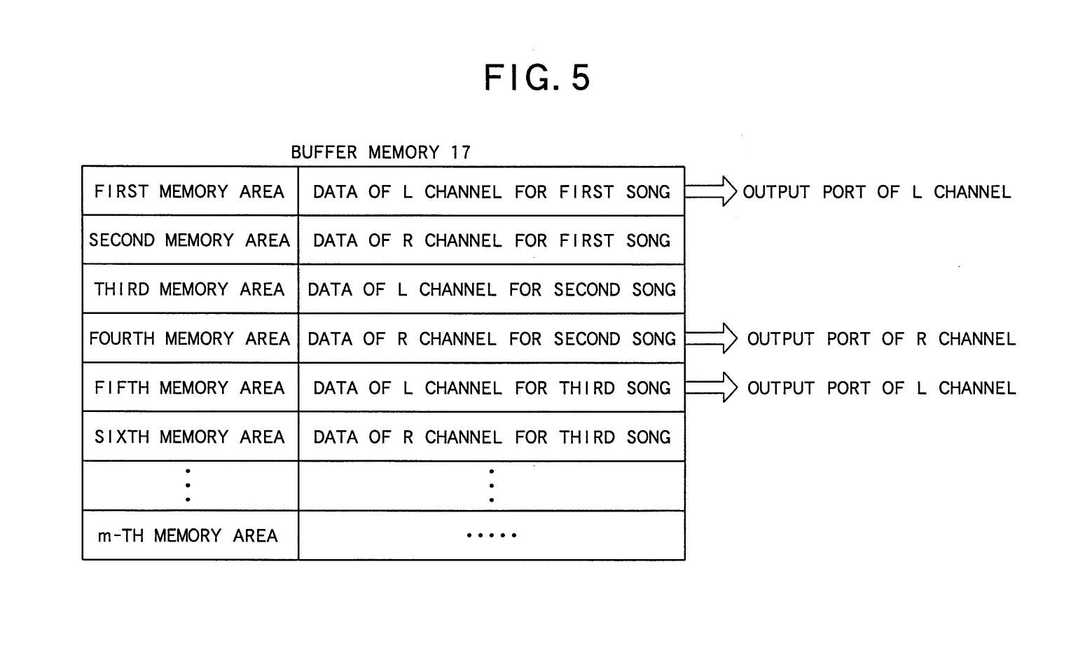

FIG. 5 is a schematic view for showing an example of content of the buffer memory 17.

As shown in FIG. 5, the buffer memory 17 has a first to m-th memory areas which can memorize data as many as a predetermined byte. Data of the L channel of the song (a predetermined time from the head) and data of the R channel are sequentially stored at a speed faster than the ordinary speed (for example quad-speed).

Further, the digital processing unit 16 reads out data of the L channel and data of the R channel respectively of songs stored in the buffer memory 17 and makes these output from output port of any one of these channels along with the allocating set-up and the output timing when the buffer memory is occupied by a certain accumulated amount. By this, it is possible to output the songs in a reproduction order or a recorded order alternately any one of the ports of the channels and so that the output timings overlap such that data of the L channel of the first song are outputted to the DAC 18a through the output port of the L channel and the data of the L channel of the third song are outputted to the DAC 18a through the output port of the L channel at a timing of outputting the data of the L channel to the DAC 18b through the output port of the R channel. These songs outputted to the DACs 18a and 18b are outwardly outputted through the amplifiers 19a and the speaker 20a and the amplifier 19b and the speaker 20b.

Meanwhile, when the song stored in the buffer memory 17 is outputted, recorded information at the head portions of the next songs are sequentially read out and stored at a speed (e.g. quad-speed) faster than the ordinary reproduction speed.

Next, the system control unit 22 judges whether the song selection search is completed, namely whether reproduction of all songs (respectively a predetermined time from the heads), recorded on the optical disc, is completed (Step S3). When it is not completed (along N in Step S3), the process goes to Step S4. When it is completed along Y in Steps S3, the process ends.

For example, when the user listens a song outputted from right and left speakers 20a, 20b by the above search operation process, the user finds a desired song, and pushes down selection button for selecting a reproduction button corresponding to one of the speakers 20a, 20b or a selection button for searching any one of the speakers 20a, 20b. Then the system control unit 22 carries out ordinary reproduction process of the song which has been outputted when the reproduction button is pushed down (Step S5) in response to the selection button thus pushed. In this ordinary reproduction process, the system control unit 22 gives an instruction of returning output allocation setup and output timing setup to an ordinary set-up (namely, data of the L channel for a song is outputted from the output port of the L channel and data of the R channel for the identical song is outputted from the output port of the R channel respectively at the same timings) to the digital signal processing unit 16. Simultaneously, information outputted when the reproduction button is pushed is obtained from the digital signal processing unit 16 and servo circuit is controlled to move the objective lens of the optical pickup to a recording position at the head of the song thereby ordinarily reproducing the song.

When the reproduction button is not pushed down in Step S4 along N of Step S4, the process goes back to Step S2 and selection song search operation processing is repeated.

As described above, according to the above embodiment, different two songs (for example, predetermined times from the heads) are respectively outputted from the speakers 20a or 20b so that a part or all of the different songs overlap. Therefore, it becomes possible to quickly search a desirable song in a short time thereby enabling to shorten a time for selecting the song.

Further, in the above embodiment, a case where the song is not compressed has been described. However, it is also possible to apply the present invention to a case where the song is compressed (for example, by MP3 or the like) and recorded on the optical disc (e.g. CD-R). In this case, for example, a decoder is provided between the digital signal processing unit 16 and the DAC 18a, 18b. After the song (the predetermined time from the head) outputted from the digital signal processing unit 16 and compressed, the song is outputted to the DAC 18a and 18b. For example, when the song is compressed (compressed down to one tenth of uncompressed song (normal song)) by the MP3 method and recorded in the optical disc and recorded onto the optical disc, it is necessary to read out at a speed about ten times faster than that for reading out the normal song. Namely, the song compressed by the MP3 method is stored in the buffer memory 17 at a speed about ten times faster than the normal song. The song stored in the buffer memory 17 is expanded by a decoder and outputted at a speed (one time speed) same as the speed for reproducing the normal song. Then by utilizing the speed of reading out by the compression, not like a case where the song is not compressed, it is possible to apply the present invention without positively controlling to enhance the rotational speed of the optical disc. The compression method is not limited to the MP3 method and other compression method such as an ATRC method is applicable.

Further, in the above embodiment, it is constructed such that outputs of the songs are alternately allocated to two channels of L channel and R channel in a reproduction order of the plurality of songs reproduced in an order of first song, second song, and third song. However, the present invention is not limited thereto. For example, it may be possible to construct such that data for a predetermined time from the head of the songs from the first song to the tenth song are stored into the buffer memory and outputs from the first song (e.g. first song; when the first song is outputted, the second song becomes the first song) and the final song (e.g. the tenth song; when the tenth song is outputted, the ninth song becomes the first song) are alternately allocated to the two channels of the L channel and the R channel. By constructing as such, songs are for example outputted from the speakers 20a, 20b so that output timings of the first and tenth songs, output timings of the second and ninth songs, output timings of the third and eighth songs, output timings of the fourth and seventh songs, and output timings of the fifth and sixth songs overlap each other. Further, it may be possible to construct such that the outputs of the songs in random combination of the plurality of songs (e.g. third and tenth songs) are allocated to the two channels of the L and R channels.

Further, in a case where the plurality of songs are recorded onto the optical disc in a state that the songs are divided into folders respectively for artists (or genres), it may be constituted such that channels are allocated to each of the artists. For example, the songs of artist AAA may be allocated to the L channel and the songs of artist BBB may be allocated to the R channel, and the songs may be outputted from the speakers 20a, 20b so that the output timings of the songs of the artist AAA and the songs of the artists BBB overlap each other. Furthermore, songs of rock music may be allocated to the L channel and the songs of classic music may be allocated to the R channel, and the songs may be outputted from the speakers 20a, 20b so that the output timings of the rock music and the classic music overlap each other.

Further, in the embodiment, an information reproduction apparatus 1 corresponding to the two channels of the L and R channels is exemplified. It is constructed such that different songs are respectively allocated to the two channels. However, the present invention is not limited thereto, and it is possible to apply the present invention to the information reproduction apparatus corresponding to 5.1 ch and 6.1 ch. For example, when the present invention is applied to the information reproduction apparatus corresponding to 5.1 ch and 6.1 ch, different songs may be respectively allocated to a center channel, a front left channel, a front right channel, a rear left channel, a rear right channel and so on. For example, the songs are outputted from speakers corresponding to the channels so that a part or the all of the output timings of these five or six songs (for example a predetermined time from the heads) overlap each other. By constructing as such, it is possible for a user to further quickly search a desirable song and shorten a time for selecting a song.

Further, in the embodiment, an example that a case where the present invention is applied to the information reproduction apparatus which reproduces a song recorded on a CD is described. However, the present invention is not limited thereto, and it is possible to apply the present invention to an information reproduction apparatus and an information reproduction and record apparatus which reproduce a songs recorded on a recording means such as DVD, MD, HD, memory card (memory stick, SD card) or the like.

Further, in the above embodiment, the song data are exemplified as the program information and the plurality of speakers (a plurality of output means of an identical kind) are respectively exemplified as the output means. However, the present invention is not limited thereto. For example, it may be possible to constitute such that the program information is image data such as movies and recorded programs, and the output means is a display means having a display screen, respectively. In this case, for example, at least two image data among a plurality of image data (e.g. a predetermined time from the head) which is reproduced, are displayed and outputted from separate display apparatuses (or dividing display screen of one display apparatus), and the plurality of image data are outputted such that a part or the all of output timings of at least the two image information overlap.

Further, in the above embodiment, it is constituted such that at least two program information pieces out of the plurality of program information (for example, song data) thus reproduced (for example song data) are outputted from separate output means, and output timings of a part or the all of the at least two program information overlap. However, it may be possible to constitute such that the at least two program information pieces are outputted from different output means without overlapping the part or the all of the output timings of at least two program information pieces.

Further, in the above embodiment, a program (including reproduction output control program) memorized in a ROM of the information reproduction apparatus 1 is for example memorized and stored in a predetermined server connected to internet. It may be possible to download the program from the server to the information reproduction apparatus or the like and memorize for example in a nonvolatile memory or an HD, or the program is read into the program, recorded on a recording medium such as CD-ROM, through a drive or the like and memorize in the nonvolatile memory or the HD thereby causing a CPU in the system control unit 22 read out the program and execute it.

Further, the present invention is not limited to the above embodiment. The embodiment is only for illustrating an example. Having substantially the same structure as a technical idea described in claims of the present invention and also having similar effects and functions thereto are included in technical scope of the present invention in its entirety.

Further, Japanese patent application No. 2005-93551 including specification, scope of claims, drawings, and summary, filed on Mar. 29, 2005 is incorporated herein by reference in its entirety.

1-8. (canceled)

9. A reproduction output control apparatus comprising:
a reproduction control device that reproduces a plurality of program information pieces recorded on a recording device; and
an output control device that causes the plurality of program information pieces be outputted in a manner that at least two program information pieces among the plurality of program information pieces are reproduced respectively from different output devices.

10. The reproduction output control apparatus according to claim 1,
wherein the output control device causes output of the plurality of program information pieces at output timings when a part or all of the at least two of the program information pieces overlap each other.

11. The reproduction output control apparatus according to claim 1, further comprising:
an output allocation device that allocates outputs of the program information pieces thus reproduced respectively to the output devices,
wherein the output control device causes the program information pieces be outputted respectively from the output devices in accordance with the allocation by the output allocation device.

12. The reproduction output control apparatus according to claim 11,
wherein the output allocation device alternately allocates outputs of the program information pieces respectively to the two output devices.

13. The reproduction output control apparatus according to claim 1,
wherein the output control device outputs the program information pieces respectively for a predetermined time from heads of the program information pieces.

14. A reproduction output control method comprising steps of:
reproducing a plurality of program information pieces recorded on a recording device; and
outputting the plurality of program information pieces thus reproduced to output at least two program information pieces out of the plurality of program information pieces from different output devices.

15. A reproduction output control processing program causing a computer to function as to:
reproduce a plurality of program information pieces recorded on a recording device; and
output the plurality of the program information pieces thus reproduced to output at least two program information pieces out of the plurality of the program information pieces thus reproduced from different output device.

16. A recording medium having the reproduction output control processing program according to claim 15 recorded on it to be readable by the computer.
